(19) United States
(12) Patent Application Publication
(10) Pub. No.: US 2009/0213232 A1
(43) Pub. Date: Aug. 27, 2009

(54) IMAGE PICKUP DEVICE

(75) Inventors: Jun Asakura, Kanagawa (JP); Kazunari Ueda, Kanagawa (JP); Koji Taniguchi, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., OSAKA (JP)

(21) Appl. No.: 11/910,160

(22) PCT Filed: Mar. 31, 2006
(86) PCT No.: PCT/JP2006/306912

§ 371 Date: Apr. 17, 2009

(30) Foreign Application Priority Data
Apr. 1, 2005 (JP) 2005-105738

(51) Int. Cl. H04N 5/228; H04N 5/225; H04N 5/232; H04N 5/235

(52) U.S. Cl. 348/208.4; 348/340; 348/347; 348/362; 348/E05.042; 348/E05.022; 348/E05.037; 348/E05.024

(57) ABSTRACT

An image pickup device by which the size of a device main body can be reduced and the assembly process can be easily automated. In the image pickup device, a wiring (118) and relay terminals (115, 116, 117, 119) for electrically connecting a shutter driving section (114) with a shutter driver (112) are integrally formed with a solid wring board (101) and a lens tube (106), respectively. An electric terminal (120) of the shutter driving section (114) for driving a shutter (107), i.e. an actuator, is electrically connected with a printed board (108) through the wiring (118) of the lens tube (106) and the wiring of the solid wiring board (101). Thus, the shutter driving section (114) is electrically connected with the shutter driver (112) which controls the shutter driving section (114) mounted on the printed board (108).

### TECHNICAL FIELD

The present invention relates to an image-pickup apparatus incorporated in a mobile device such as a mobile telephone apparatus.

### BACKGROUND ART

With the trend toward implementation of smaller and slimmer mobile devices such as mobile telephone apparatus in recent years, there is also a demand for smaller and slimmer image-pickup apparatuses incorporated therein.

Among image-pickup apparatuses that meet such a demand, an image-pickup apparatus is conventionally known which is configured to perform planar (two-dimensional) positioning of an photographing optical system, movable optical members included therein, at least some of actuator components and solid image-pickup element with respect to a substrate (e.g., see Patent Document 1).

Furthermore, among similar image-pickup apparatuses, an image-pickup apparatus is known which is configured to accommodate a wiring board, IC, chip parts and parts such as connectors in a space between a lens barrel and the back side of the image-pickup element (e.g., see Patent Document 2).

FIG. 1 is a schematic cross-sectional view showing the configuration of a conventional image-pickup apparatus. As shown in FIG. 1, conventional image-pickup apparatus 20 is provided with three-dimensional wiring board 21, image-pickup element 23, barrel 26, shutter 27, printed circuit board 28, lens 33 and so on.

In FIG. 1, three-dimensional wiring board 21 is provided with opening 22. From the light which passes through opening 22 of three-dimensional wiring board 21, an image is formed by lens 33 on image-pickup element 23 as an image of an object and converted to an electric signal by image-pickup element 23.

Image-pickup element 23 that takes an image of an object is electrically connected to terminals 24 formed on one surface (underside in the figure) of three-dimensional wiring board 21 through three-dimensional wiring board 21. In this way, three-dimensional wiring board 21 and image-pickup element 23 form one sensor package 25.

Sensor package 25 is mounted on printed circuit board 28 and connected to image-pickup element control section 29 for controlling image-pickup element 23 mounted on printed circuit board 28 through printed circuit board 28.

Barrel 26 is mounted on three-dimensional wiring board 21 of sensor package 25. Furthermore, shutter 27 that opens and closes the image-pickup optical path of image-pickup element 23 and shutter drive section 34 as a shutter drive means that electrically drives shutter 27, are mounted on barrel 26.

Wiring 30 that extends from a terminal of shutter drive section 34 is attached to a side of shutter drive section 34. This wiring 30 that extends from the terminal of the shutter drive section 34 is connected to printed circuit board 28 through connector 31. By the way, this connection may also be a solder connection. In this way, shutter drive section 34 is electrically connected to shutter driver 32 as a shutter control means for controlling shutter drive section 34 mounted on printed circuit board 28.
Patent Document 1: Japanese Patent Application Laid-Open No. HEI 8-237531
Patent Document 2: Japanese Patent Application Laid-Open No. 2002-299592

### DISCLOSURE OF INVENTION

### Problems to be Solved by the Invention

However, as shown in FIG. 1, above described conventional image-pickup apparatus 20 connects shutter drive section 34 and printed circuit board 28 using wiring 30 and connector 31 which pass outside barrel 26.

Therefore, conventional image-pickup apparatus 20 has a configuration with wiring 30 which connects shutter drive section 34 and printed circuit board 28 protruding sideward from barrel 26, which requires a space to accommodate wiring 30 and connector 31.

This space to accommodate wiring 30 and connector 31 constitutes a cause for increasing the body size of the apparatus and has an influence on the layout for incorporating image-pickup apparatus 20 into a mobile device, which constitutes a big problem for the mobile device required to be smaller and slimmer.

Furthermore, this type of conventional image-pickup apparatus often uses a magnet for the shutter drive section that electrically drives the shutter, and such a magnet cannot be mounted through a reflow.

Therefore, for example, as shown in FIG. 1, in the conventional image-pickup apparatus, image-pickup element 23 is mounted on three-dimensional wiring board 21 through a reflow and then barrel 26, shutter 27 and shutter drive section 34 and so on are attached to three-dimensional wiring board 21. The terminal of this shutter drive section 34 then needs to be led out by wiring 30 such as a lead wire or a flexible substrate, and the terminal of shutter driver 32 which is mounted on printed circuit board 28 and wiring 30 need to be electrically connected through connector 31.

The assembly process of such a conventional image-pickup apparatus is hard to be automated and also constitutes a factor that obstructs productivity.

It is therefore an object of the present invention to provide an image-pickup apparatus that has a small apparatus size and that makes it easier to automate the assembly process.

### Means for Solving the Problem

The image-pickup apparatus of the present invention adopts a configuration including: an image-pickup element that takes an image of an object; a wiring board on which the image-pickup element is mounted; a barrel provided on the wiring board; an actuator that is provided on the barrel and electrically driven; and a control section that controls the actuator, and, in this apparatus, a relay terminal and a wiring for electrically connecting the actuator and the control section are formed integral with at least one of the barrel and the wiring board.

The image-pickup apparatus of the present invention adopts a configuration including: a sensor package provided with an image-pickup element that takes an image of an object; a wiring board on which the sensor package is mounted; a barrel provided on the sensor package; an actuator that is provided on the barrel and electrically driven; and a control section that controls the actuator, and, in this apparatus, a relay terminal and a wiring for electrically connecting the actuator and the control section are formed integral with at least one of the barrel and the sensor package.

### Advantageous Effect of the Invention

According to the present invention, the wiring and the connection terminal for electrically connecting the above shutter drive section and the above shutter control section are formed integral with each of the above barrel and the above three-dimensional wiring board, so that the wiring does not protrude from the side of the barrel, the connector also becomes unnecessary and the apparatus size can be reduced. Furthermore, according to the present invention, since the above shutter drive section and the above shutter control section are electrically connected by attaching the above barrel to the above three-dimensional wiring board, it is easier to automate the assembly process. Moreover, making of the image-pickup apparatus smaller provides ease of layout and improves designability of an electronic device using the image-pickup element according to the present invention.

### BRIEF DESCRIPTION OF DRAWINGS

FIG. 1 is a schematic cross-sectional view showing the configuration of a conventional image-pickup apparatus; and

FIG. 2 is a schematic cross-sectional view showing the configuration of an image-pickup apparatus according to an embodiment of the present invention.

### BEST MODE FOR CARRYING OUT THE INVENTION

Hereinafter, an embodiment of the present invention will be described in detail with reference to the attached drawings. FIG. 2 is a schematic cross-sectional view showing the configuration of an image-pickup apparatus according to an embodiment of the present invention.

As shown in FIG. 2, image-pickup apparatus 100 in this embodiment is provided with three-dimensional wiring board 101, image-pickup element 103, barrel 106, shutter 107, printed circuit board 108, lens 113 and so on.

In FIG. 2, three-dimensional wiring board 101 is provided with opening 102. From the light that passes through opening 102 of three-dimensional wiring board 101, an image is formed by lens 113 on image-pickup element 103 as an image of an object and converted to an electric signal by image image-pickup element 103.

Image-pickup element 103 that captures an image of an object is electrically connected to terminal 104 formed on one surface (underside in the figure) of three-dimensional wiring board 101 through three-dimensional wiring board 101. In this way, three-dimensional wiring board 101 and image-pickup element 103 form one sensor package 105.

Sensor package 105 is mounted on printed circuit board 108 and connected to image-pickup element control section 109 for controlling image-pickup element 103 mounted on printed circuit board 108 through printed circuit board 108.

Barrel 106 is mounted on three-dimensional wiring board 101 of sensor package 105. Furthermore, shutter 107 that opens and closes the image-pickup optical path of image-pickup element 103 and shutter drive section 114 as a shutter drive means that electrically drives shutter 107, are mounted on barrel 106.

The underside of three-dimensional wiring board 101 is provided with relay terminals 115 for electrically connecting shutter drive section 114 with printed circuit board 108 in addition to terminals 104 that connects image-pickup element 103. This relay terminal 115 is electrically connected to other relay terminal 116 provided on the top surface of three-dimensional wiring board 101 through a wiring which passes inside three-dimensional wiring board 101.

Relay terminal 116 provided on the top surface of this three-dimensional wiring board 101 is connected to other relay terminal 117 provided on the underside of barrel 106 when barrel 106 is mounted on three-dimensional wiring board 101.

Relay terminal 117 provided on the underside of this barrel 106 is electrically connected to other relay terminal 119 provided on the top surface of barrel 106 through wiring 118 which passes inside barrel 106.

Relay terminal 119 provided on the top surface of this barrel 106 is connected to electric terminal 120 provided on the underside of shutter drive section 114 when shutter drive section 114 is mounted on barrel 106.

Electric terminal 120 of shutter drive section 114 for driving shutter 107 which is an actuator is electrically connected to printed circuit board 108 through wiring 118 of barrel 106 and a wiring of three-dimensional wiring board 101. Shutter drive section 114 is then electrically connected to shutter driver 112 as a shutter control section for controlling shutter drive section 114 mounted on printed circuit board 108.

Shutter driver 112 controls shutter drive section 114 and opens and closes shutter 107. Through opening/closing of this shutter, incident light from the object is exposed to image-pickup element 103 through lens 113 and opening 102 of three-dimensional wiring board 101.

As described above, as for image-pickup apparatus 100 in this embodiment, wiring 118 for electrically connecting shutter drive section 114 and shutter driver 112 and relay terminals 115, 116, 117 and 119 are formed integral with each of three-dimensional wiring board 101 and barrel 106.

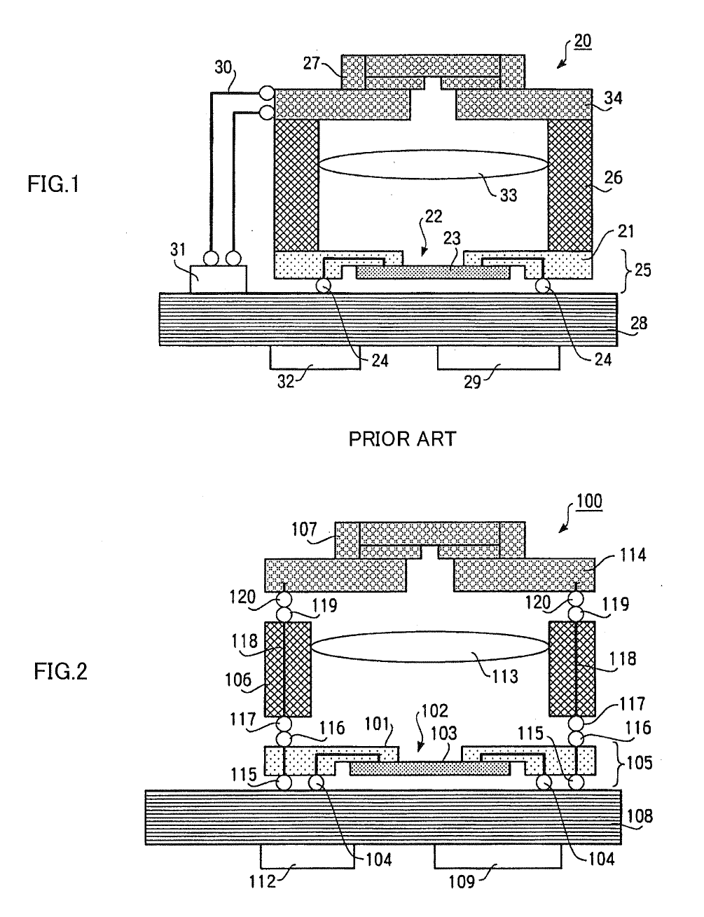

Therefore, image-pickup apparatus 100 of this embodiment does not have the configuration of conventional image-pickup apparatus 20 as shown in FIG. 1 in which wiring 30 considerably protrudes sideward from barrel 26, also eliminates the necessity for connector 31, and can thereby reduce the size of the apparatus.

Furthermore, according to image-pickup apparatus 100 of this embodiment, barrel 106 is mounted on three-dimensional wiring board 101 as described above, and it is thereby possible to electrically connect shutter drive section 114 and shutter driver 112 and make it easier to automate the assembly process.

The figure shows an example of image-pickup apparatus 100 where wiring 118 is formed inside barrel 106, but this wiring 118 may also be formed on the internal circumferential surface or external circumferential surface of barrel 106.

Furthermore, wiring 118 may also be configured so as to directly connect electric terminals 120 of shutter drive section 114 and the package terminals provided for sensor package 105.

Furthermore, the figure shows an example of image-pickup apparatus 100 where shutter 107, shutter drive section 114 and barrel 106 are formed separately and joined together, but shutter 107, shutter drive section 114 and barrel 106 may also be integrally formed.

Furthermore, the figure shows an example of image-pickup apparatus 100 where barrel 118 is provided on sensor package 105 made up of three-dimensional wiring board 101 and image-pickup element 103, but image-pickup element 103 and barrel 106 may also be directly provided on printed circuit board 108.

Furthermore, the figure shows an example of image-pickup apparatus 100 where the actuator section is made up of shutter 107 and shutter drive section 114, but this actuator section may also be, for example, an iris, a macro mechanism, a neutral density filter, an auto focus mechanism, a zooming mechanism or a camera shake correction mechanism of image-pickup apparatus 100.

The image-pickup apparatus according to a first aspect of the present invention adopts a configuration including: an image-pickup element that takes an image of an object; a wiring board on which the image-pickup element is mounted; a barrel provided on the wiring board; an actuator that is provided on the barrel and electrically driven; and a control section that controls the actuator, and, in this apparatus, a relay terminal and a wiring for electrically connecting the actuator and the control section are formed integral with at least one of the barrel and the wiring board.

The image-pickup apparatus according to a second aspect of the present invention adopts the configuration of the above described first aspect including: a sensor package provided with an image-pickup element that takes an image of an object; a wiring board on which the sensor package is mounted; a barrel provided on the sensor package; an actuator that is provided on the barrel and electrically driven; and a control section that controls the actuator, and, in this apparatus, a relay terminal and a wiring for electrically connecting the actuator and the control section are formed integral with at least one of the barrel and the sensor package.

The image-pickup apparatus according to a third aspect of the present invention adopts the configuration of the above described second aspect, and, in this apparatus, the relay terminal electrically connects the actuator and the control section when the barrel is disposed on the sensor package and the actuator is disposed on the barrel.

The image-pickup apparatus according to a fourth aspect of the present invention adopts the configuration of the above described first aspect, and, in this apparatus, the wiring is formed inside the barrel.

The image-pickup apparatus according to a fifth aspect of the present invention adopts the configuration of the above described first aspect, and, in this apparatus, the wiring is formed on an internal circumferential surface of the barrel.

The image-pickup apparatus according to a sixth aspect of the present invention adopts the configuration of the above described first aspect, and, in this apparatus, the wiring is formed on an external circumferential surface of the barrel.

The image-pickup apparatus according to a seventh aspect of the present invention adopts the configuration of the above described first aspect, and, in this apparatus, the barrel and the actuator are formed integral with each other.

The image-pickup apparatus according to an eighth aspect of the present invention adopts the configuration of the above described first aspect, and, in this apparatus, the actuator comprises a shutter that shields light incident on the image-pickup element.

The image-pickup apparatus according to a ninth aspect of the present invention adopts the configuration of the above described first aspect, and, in this apparatus, the actuator comprises an iris that adjusts an amount of light incident on the image-pickup element.

The image-pickup apparatus according to a tenth aspect of the present invention adopts the configuration of the above described first aspect, and, in this apparatus, the actuator comprises a neutral density filter that dims light incident on said image-pickup element.

The image-pickup apparatus according to an eleventh aspect of the present invention adopts the configuration of the above described first aspect, and, in this apparatus, the actuator comprises a macro mechanism for taking a macro shot of the object.

The image-pickup apparatus according to a twelfth aspect of the present invention adopts the configuration of the above described first aspect, and, in this apparatus, the actuator comprises an auto focus mechanism that automatically adjusts a focal position of the image-pickup element.

The image-pickup apparatus according to a thirteenth aspect of the present invention adopts the configuration of the above described first aspect, and, in this apparatus, the actuator comprises a zooming mechanism for taking a zoom shot of the object.

The image-pickup apparatus according to a fourteenth aspect of the present invention adopts the configuration of the above described first aspect, and, in this apparatus, the actuator comprises a camera shake correction mechanism that corrects camera shake of the object.

The present application is based on Japanese Patent Application No. 2005-105738, filed on Apr. 1, 2005, the entire content of which is expressly incorporated by reference herein.

### INDUSTRIAL APPLICABILITY

The image-pickup apparatus according to the present invention can reduce the size of the apparatus and make it easier to automate the assembly process and is therefore suitable for use in an image-pickup apparatus incorporated in a mobile device such as a mobile telephone apparatus. Furthermore, an electronic device and a communication terminal using the image-pickup apparatus according to the present invention can reduce the apparatus size, and is therefore suitable for mobile applications.

1. An image-pickup apparatus comprising:
an image-pickup element that takes an image of an object;
a wiring board on which the image-pickup element is mounted;
a barrel provided on the wiring board;
an actuator that is provided on the barrel and electrically driven; and
a control section that controls the actuator,
wherein a relay terminal and a wiring for electrically connecting the actuator and the control section are formed integral with at least one of the barrel and the wiring board.

2. An image-pickup apparatus comprising:
a sensor package provided with an image-pickup element that takes an image of an object;
a wiring board on which the sensor package is mounted;
a barrel provided on the sensor package;
an actuator that is provided on the barrel and electrically driven; and
a control section that controls the actuator,
wherein a relay terminal and a wiring for electrically connecting the actuator and the control section are formed integral with at least one of the barrel and the sensor package.

3. The image-pickup apparatus according to claim 2, wherein the relay terminal electrically connects the actuator and the control section when the barrel is disposed on the sensor package and the actuator is disposed on the barrel.

4. The image-pickup apparatus according to claim 1, wherein the wiring is formed inside the barrel.

5. The image-pickup apparatus according to claim 1, wherein the wiring is formed on an internal circumferential surface of the barrel.

6. The image-pickup apparatus according to claim 1, wherein the wiring is formed on an external circumferential surface of the barrel.

7. The image-pickup apparatus according to claim 1, wherein the barrel and the actuator are formed integral with each other.

8. The image-pickup apparatus according to claim 1, wherein the actuator comprises a shutter that shields light incident on the image-pickup element.

9. The image-pickup apparatus according to claim 1, wherein the actuator comprises an iris that adjusts an amount of light incident on the image-pickup element.

10. The image-pickup apparatus according to claim 1, wherein the actuator comprises a neutral density filter that dims light incident on said image-pickup element.

11. The image-pickup apparatus according to claim 1, wherein the actuator comprises a macro mechanism for taking a macro shot of the object.

12. The image-pickup apparatus according to claim 1, wherein the actuator comprises an auto focus mechanism that automatically adjusts a focal position of the image-pickup element.

13. The image-pickup apparatus according to claim 1, wherein the actuator comprises a zooming mechanism for taking a zoom shot of the object.

14. The image-pickup apparatus according to claim 1, wherein the actuator comprises a camera shake correction mechanism that corrects camera shake of the object.

15. An electronic apparatus using the image-pickup apparatus according to claim 1.

16. A communication terminal using the image-pickup apparatus according to claim 1.
